(19) United States
(12) Patent Application Publication
(10) Pub. No.: US 2004/0220762 A1
(43) Pub. Date: Nov. 4, 2004

(54) On-site, in-situ application calibration service

(76) Inventors: Robert E. Oeflein, Veradale, WA (US); Glen C. Miller, Algonquin, IL (US); Russell A. Caroli, Maywood, NJ (US); Charles Warren Ford, San Jose, CA (US); David J. Robinson, Hood River, OR (US); Greg C. Richtenburg, Sebastopol, CA (US); James C. Harmon, Spokane, WA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/428,911

(22) Filed: May 2, 2003

(51) Int. Cl. G06F 19/00

(52) U.S. Cl. 702/107

(57) ABSTRACT

On-site, in-situ verification of production test equipment. Verification of production test equipment is performed using a mobile rack of electronic test equipment which may be moved through a production environment. Calibration tests are only performed on those measurements critical to the production environment, not over the operating range of the equipment. Calibration tests may be performed in parallel to reduce the time required.

### BACKGROUND OF THE INVENTION

1. Field of the Invention

The present invention pertains to the art of calibrating test equipment, and more particularly, to the application-specific calibration of test equipment in production environments.

2. Art Background

An important part of the production of modern electronic devices, such as wireless devices, is the verification of device operation and of important device operating parameters. This verification is typically performed by test equipment on a production line. An array of test equipment provides test signals to a device under test, and measures results from the device under test. It is common in production environments to have multiple test stations, and in some cases, to run these test stations for multiple shifts.

A problem arises in verifying the operational accuracy of the test equipment used in these test stations.

Current calibration processes used to verify the operational accuracy of test equipment require that the equipment be taken out of production test use, removed from the production environment, and transported to a central calibration area, or even to the test equipment vendor for calibration. This means that the test capability supplied by that equipment is not available for production use for a period of days or even weeks.

The customer is thus faced with either running at reduced test capacity, or of having to have spares available to replace the equipment which is out for calibration. These spares must themselves be recalibrated periodically, and add cost to the testing process, both in the costs of the spares and the cost to swap units in and out of service for calibration.

### SUMMARY OF THE INVENTION

An on-site, in-situ calibration service uses a mobile rack of electronic test equipment which can be moved through a production environment. The use of captive cables and calibration factors allows calibration services to be delivered with minimum interruption to production flow on adjacent systems. To reduce calibration procedure run times, calibration tests are only performed on those measurements critical to the device under test. Calibration tests may be performed in parallel to reduce the time required.

### BRIEF DESCRIPTION OF THE DRAWINGS

The present invention is described with respect to particular exemplary embodiments thereof and reference is made to the drawings in which:

FIG. 1 shows a hardware configuration for the present invention, and

FIG. 2 shows a software configuration for the present invention.

### DETAILED DESCRIPTION

Production of modem electronic devices such as wireless communications devices includes testing of the devices to insure they meet operating parameters specified by both regulatory and customer requirements. In the case of a wireless device, such parameters may include transmitter power output characterized over varying battery voltage levels, transmitter purity and stability, receiver sensitivity and selectivity, as well as product specific features. These tests are performed by having the test equipment provide test signals to a device under test and using the test equipment to measure results. These test systems are typically highly automated. In high-volume production facilities, it is common to have multiple production test lines, each having an array of test equipment, which may be run over multiple shifts.

The production test equipment must not only perform the required tests quickly, but also reliably. The operator of the production facility is faced with the problem of insuring that the multiple arrays of test equipment on multiple production test lines are all operating properly.

Current calibration processes used to verify test equipment performance require the equipment to be taken out of production test service, removed from the production environment and transported to a central calibration area or even to the test equipment vendor for calibration. This takes the equipment out of production use for a period of days or even weeks.

The operator of the production facility must either operate with reduced test capacity, or must mitigate such shortfalls by keeping a set of spares available to replace equipment which is out for calibration. Of course these spares must themselves be calibrated.

In accordance with the present invention, an on-site, in-situ calibration service uses a mobile calibration unit comprising a rack of electronic test equipment which can be moved through the production environment. Providing the accuracy and measurement capability that is required for these calibrations in a small enough rack is accomplished by selecting multifunctional standards and by transferring accuracy from other standards. The resulting transfer accuracy data is stored as correction factors for a variety of measurements. This eliminates the requirement to have the physical presence of certain standards in the rack and provides a small size with similar measurement capability supplied by a large series of racks.

The selection of test equipment for the mobile calibration unit will depend on the tests which need to be performed to validate the performance of the production test equipment. For example, if the production test equipment has one or more power supplies for supplying different voltages to the device under test, the mobile calibration unit must provide suitable loads and voltmeters to verify the performance of the power supplies. Similarly, RF sources, power meters, and receivers may be required to calibrate the RF test equipment in a production test environment for wireless devices.

The mobile calibration unit is equipped with test leads long enough to permit the production test equipment to be verified without disturbing adjacent production test systems. The mobile calibration unit may attach to the production test equipment via the existing connectors on the production test equipment, or through a production test fixture.

In providing long test leads, it is important that the mobile calibration unit itself be calibrated with these long test leads. The effects of long leads will be especially significant, for example, when measuring high frequency signals such as those in the 1900 MHz range used by wireless devices.

Production test systems are commonly assembled from commercially available test equipment, for example, power supplies, signal sources, power meters, and the like. These pieces of test equipment are commonly capable of a much wider range of operation than is used in the production test environment for a particular device. As an example, while a DC power supply such as the E3645A from Agilent Technologies is capable of delivering DC power over a voltage range from 0 to 35 volts at up to 2.2 amperes, in a production test environment it may only be used from 3 to 9 volts at from 50 to 900 milliamps. An RF signal source may be specified over a range of 1 to 2400 MHz, yet only be used from 800 to 900 MHz, and 1700 to 1900 MHz in a wireless test application.

According to the present invention, the mobile calibration unit only verifies correct operation of the production test equipment in the operating regions used in the production environment. As an example, a DC power supply which is used to product voltages from 3 to 9 volts in a production test environment is only tested in that range, and not over its full range of operation as would normally be done in a complete instrument calibration. An RF signal source would only be tested in the range used in the production test environment, and not over its full range of operation. By restricting calibration tests to those of interest in the production environment, test time can be greatly reduced.

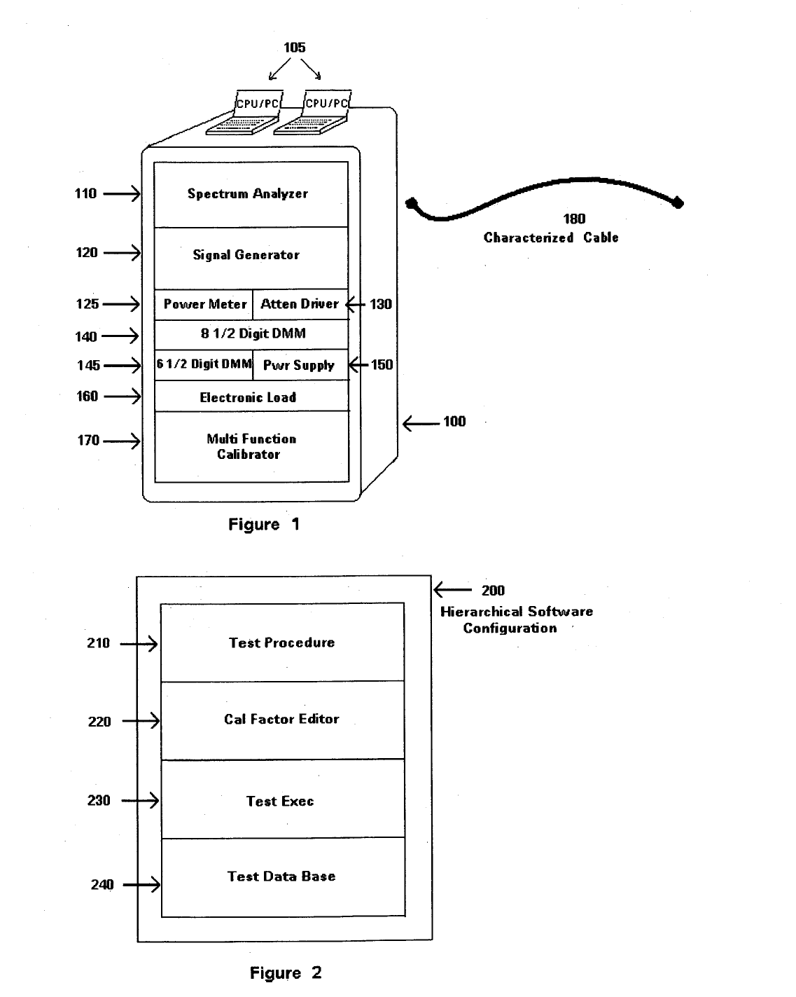

FIG. 1 shows the hardware configuration of a mobile calibration unit suitable for verifying wireless test stations. The actual equipment used will of course depend on the characteristics needing to be verified. In FIG. 1, mobile rack 100 contains one or more controlling CPUs1O5, which may be a standard personal computer equipped with the necessary I/O ports needed to communicate with the remaining test equipment. These ports include but are not limited to IEEE-488, also known as GPIB, Ethernet, USB, and serial ports. Having more than one CPUs 105, or a single CPU capable of running multiple programs at once enables the mobile rack 100 to run parallel calibrations to reduce the time required. Mobile rack 100 contains a spectrum analyzer 110, such as the E4440A from Agilent technologies, for verifying the operation of signal sources. Signal generator 120, for example the E4438C from Agilent Technologies, is used to verify the operation of receivers. Power meter 125, such as the Agilent E4417A measures RF power. Switching unit 130 is being used as an attenuator driver. The main purpose for this is to transfer the accuracy of a calibrated step attenuator and power sensor to the spectrum analyzer. A switching unit may also be added to route signals from rack 100 through the characterized interconnecting cables 180 to the equipment in the production rack under control of CPU 105.

Multimeter 140, such as the Agilent 3458A, provides the ability to measure AC and DC voltages and current. For testing power supplies, electronic load 160 such as the Agilent 6060B is provided. Multimeter 145, such as the Agilent 34401A, is used to enable the parallel calibration of power supplies and RF instruments using separate controlling CPU 105. Power supply 150, such as the Agilent E3645A, is used to calibrate power supplies with built-in DMMs. A general purpose calibrator 170 such as the Fluke 5520 provides audio, AC, and DC test signals. A suitable enclosure for mobile rack 100 is produced by Hardigg Industries, Inc. which allows the system to be packaged in a shippable rack with shock mounts which can be set up quickly at a customer site and wheeled directly on to the test floor.

The equipment in rack 100 connects through various I/O ports to CPU 105. CPU 105 controls the various pieces of test equipment, sequencing tests, and captures test data from the units under test in the production test system which is being verified. CPU 105 performs tests, and records results for later printout.

To perform effective testing, the accuracy of measurements must be insured. FIG. 2 shows a hierarchical software configuration 200 for the present invention. Test Procedure 210 drives testing using the lower layers. Calibration factor editor 220 allows the setup and maintenance of calibration factors through the test hardware used to transfer accuracy. As a first example, interconnect cables 180 will introduce losses between test rack 100 and the production test equipment being tested. Calibration factors must be introduced to compensate for these effects. The resulting characterized cables 180 are then used to perform the calibrations. In the RF domain, additional calibration factors must be included in the measurements performed by spectrum analyzer 110, signal generator 120, and RF power meter 125. Test Executive230 uses Test Procedure 210 to perform individual test steps and record results in the Test Database 240.

By using multiple pieces of equipment in the mobile calibration unit, test time may be further reduced by performing some tests in parallel. For example, spectrum analyzer 110 of FIG. 1 may be used to take measurements of signal sources at the same time programmable load 160 is being used to test power supplies. Having Test Procedure 210 of FIG. 2 only perform tests covering the operating regions of use, rather than on the full operating capability of the production test equipment also reduces test time.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. The method of maintaining calibration in a plurality of production test systems, each test system comprising a plurality of test equipment to be calibrated, comprising:
providing a mobile calibration unit capable of providing calibration services to the plurality of test equipment,
moving the mobile calibration unit to a first production test system,
connecting the mobile calibration unit to the first production test system,
performing calibration of the test equipment in the first production test system, and
moving the mobile calibration unit to a second production test system.

2. The method of claim 1 where the step of performing calibration of the test equipment is performed serially.

3. The method of claim 1 where the step of performing calibration of the test equipment is performed such that a plurality of the test equipment is under calibration at the same time.

4. The method of claim 1 where the step of performing calibration of the test equipment is performed with respect to ranges and values of interest in the production test system.

5. The method of claim 1 where the mobile calibration unit and associated connection cables are calibrated.

6. The method of claim 1 where the mobile calibration unit and its cables are designed so that the step of performing calibration of the test equipment in a first production test system is performed without interrupting production flow on adjacent production test systems.
